(19) United States
(12) Patent Application Publication
(10) Pub. No.: US 2020/0376783 A1
(43) Pub. Date: Dec. 3, 2020

(54) Trimming System for Composite Structures

(71) Applicant: The Boeing Company, Chicago, IL (US)

(72) Inventors: Jonathan Young Ahn, Tukwila, WA (US); Silas Lawton Studley, Seattle, WA (US); Lisa Christina Carlson, Tukwila, WA (US); Jake A. Reeves, Chicago, IL (US); Gregory P. Freed, Chicago, IL (US); Darrell Darwin Jones, Mill Creek, WA (US)

(21) Appl. No.: 16/423,512

(22) Filed: May 28, 2019

(51) Int. Cl. B29C 70/54; B29C 70/34

(52) U.S. Cl. CPC B29C 70/545; B29K 2105/0872; B29C 70/342

(57) ABSTRACT

A composite manufacturing system is provided. The composite manufacturing system comprises a robotic arm and a trimming system connected to the robotic arm. The trimming system comprises a knife, a rotation device, a number of lasers, and a load cell associated with the knife. The rotation device is configured to rotate a blade of the knife about a center point. The number of lasers is configured to determine a position of the blade relative to a desired position for the blade. The load cell is configured to sense an amount of force applied to the blade during trimming of an uncured composite structure. A controller controls the behavior of the trimming system based on information received from its components.

### BACKGROUND INFORMATION

### 1. Field

The present disclosure relates generally to manufacturing composite structures. More specifically, the present disclosure relates to a trimming system used in manufacturing composite structures for aircraft applications.

### 2. Background

Manufacturers use composite structures to provide light-weight and structurally sound parts for various applications. Increasing the efficiency of the composite manufacturing process is a priority for aircraft manufacturers. They seek to lower costs and increase the rate at which an aircraft is produced while minimizing the risk of rework or discarding of composite parts during the process.

In fabricating parts, composite structures are trimmed into desired configurations. Trimming may be a time-consuming and complex process. Some composite structures used for aircraft applications are 70+ feet in length. Orienting and moving such large structures about a manufacturing floor requires time, space, and manpower.

A composite structure may be trimmed into its desired configuration prior to or after curing. When the composite structure is trimmed prior to curing or bonding, the composite material is soft, making it difficult to maintain the integrity of the cut. To combat this challenge, the composite structure is cut while under vacuum using an ultrasonic knife. Still, the delicate state of the uncured composite material may lead to knife blade deflection or inconsistencies at different areas of thickness of the cut. In some cases, the deflection is so great that it risks deforming or breaking the knife blade.

Therefore, it would be desirable to have a method and apparatus that takes into account at least some of the issues discussed above, as well as other possible issues.

### SUMMARY

An illustrative embodiment of the present disclosure provides a composite manufacturing system comprising a robotic arm and a trimming system connected to the robotic arm. The trimming system comprises a knife, a rotation device, a number of lasers, and a load cell associated with the knife. The rotation device is configured to rotate a blade of the knife about a center point. The number of lasers is configured to determine a position of the blade relative to a desired position for the blade. The load cell is configured to sense an amount of force applied to the blade during trimming of an uncured composite structure.

Another illustrative embodiment of the present disclosure provides a method for trimming an uncured composite structure. A trimming system is positioned relative to the uncured composite structure. The trimming system is connected to a robotic arm. A blade of a knife in the trimming system is aligned with a start position for a cut. The uncured composite structure is trimmed along a path. Parameters for the knife are adjusted based on the amount of force applied to the blade during trimming.

A further illustrative embodiment of the present disclosure provides a composite manufacturing system for trimming an uncured composite structure for an aircraft. The composite manufacturing system comprises a tool, a robotic arm, and a trimming system connected to the robotic arm. The trimming system comprises a knife, a rotation device, a number of lasers, a load cell associated with the knife, and a controller. The uncured composite structure is laid up on the tool.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a perspective view of a composite manufacturing system in accordance with an illustrative embodiment;

FIG. 2 is an illustration of a block diagram of a manufacturing environment in accordance with an illustrative embodiment;

FIG. 3 is an illustration of a perspective view of a trimming system in accordance with an illustrative embodiment;

FIG. 4 is an illustration of a side view of a trimming system in accordance with an illustrative embodiment;

FIG. 5 is an illustration of a top view of a trimming system in accordance with an illustrative embodiment;

FIG. 6 is an illustration of an exploded view of a trimming system in accordance with an illustrative embodiment;

FIG. 7 is an illustration of a knife blade in accordance with an illustrative embodiment;

FIG. 8 is another illustration of a knife blade in accordance with an illustrative embodiment;

FIG. 9 is an illustration of a perspective view of a cut in an uncured composite structure in accordance with an illustrative embodiment;

FIG. 10 is an illustration of a cross-sectional view of a cut in an uncured composite structure in accordance with an illustrative embodiment;

FIG. 11 is a cross-sectional view of a composite stringer in accordance with an illustrative embodiment;

FIG. 12 is an illustration of a flowchart of a process for trimming an uncured composite structure in accordance with an illustrative embodiment;

FIG. 13 is another illustration of a flowchart of a process for trimming an uncured composite structure for an aircraft in accordance with an illustrative embodiment;

FIG. 14 is yet another illustration of a flowchart of a process for trimming an uncured composite structure for an aircraft in accordance with an illustrative embodiment;

FIG. 15 is an illustration of a block diagram of an aircraft manufacturing and service method in accordance with an illustrative embodiment; and

FIG. 16 is an illustration of a block diagram of an aircraft in which an illustrative embodiment may be implemented.

### DETAILED DESCRIPTION

The illustrative embodiments recognize and take into account one or more different considerations. For example, the illustrative embodiments recognize and take into account that current manufacturing processes for composite structures may present challenges in efficiency of production. Composite parts, such as stringers used for aircraft, require additional trimming before being bonded to other composites to complete the structure. Since these parts are trimmed before curing or bonding, the delicate material risks smashing and deformation from the knife blade.

The illustrative embodiments also recognize and take into account that many trimming systems for composites are mounted onto large, immobile structures in the manufacturing environment. For instance, a trimming system may be mounted to a gantry which can move in only one or two directions relative to the structure. As a result, the composites must be moved, flipped, or otherwise oriented with reference to the gantry system. Since some composite parts are seventy feet or more in length, orientation becomes more difficult and time consuming than desired. These gantry systems also require extensive floor space and cannot cut multiple segments of the part simultaneously.

Further, the illustrative embodiments recognize and take into account that the trim angle and setup of the system are important variables to the success of the cut. Ultrasonic knives are designed to have a stop feature that prevents blade deflection from snapping or breaking the blade. During trimming, if the blade comes in contact with the tool, it will deflect toward the composite, resulting in not only deflection of the blade but also inconsistencies in the cut. Blade shape is critical to the integrity of the cut. Some blade shapes do not trim composites as desired.

Thus, the disclosed embodiments provide a composite manufacturing system having a robotic arm and a trimming system connected to the robotic arm. The trimming system comprises a knife, a rotation device, a number of lasers, and a load cell associated with the knife. The rotation device is configured to rotate a blade of the knife about a center point. The number of lasers is configured to determine a position of the blade relative to a desired position for the blade. The load cell is configured to sense an amount of force applied to the blade during trimming of an uncured composite structure. The blade comprises a first side having a double-beveled shape and a second side opposite the first side having a planar shape. The blade trims the uncured composite structure using the second side. A layer of porous material is positioned between the uncured composite structure and the tool to minimize blade deflection during trimming. Composite structures may be trimmed prior to or after curing and multiple robots may move about the manufacturing environment to trim the composite structure at the same time.

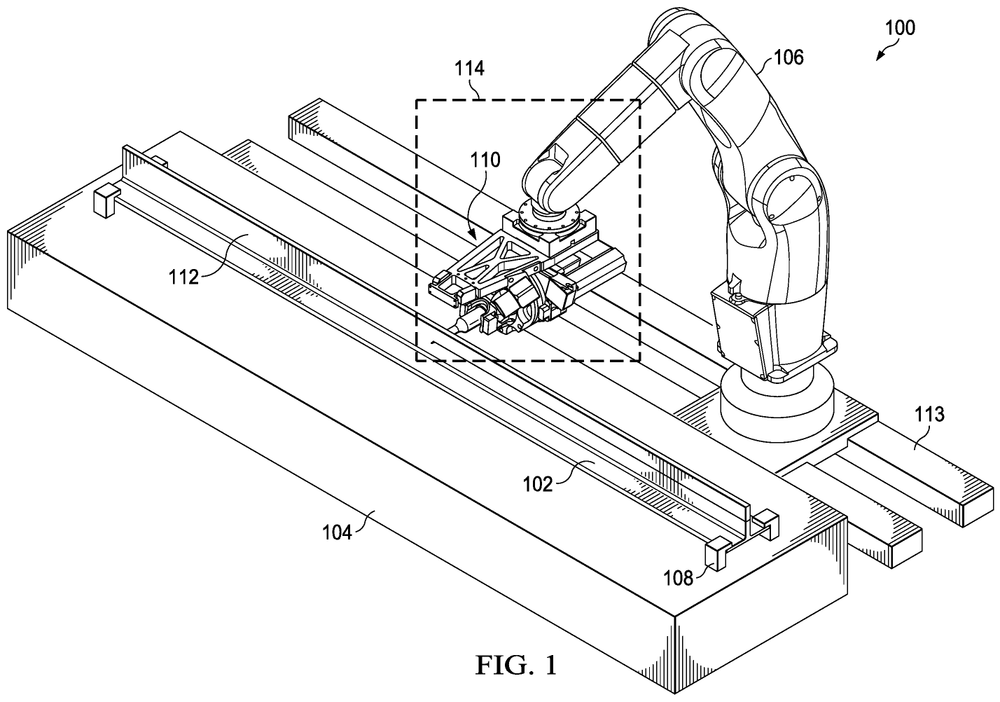

With reference now to the figures and, in particular, with reference to FIG. 1, an illustration of a perspective view of a composite manufacturing system is depicted in accordance with an illustrative embodiment. Composite manufacturing system 100 comprises a combination of automated components and/or devices capable of performing processing on uncured composite structure 102.

As depicted, composite manufacturing system 100 includes tool 104, robotic arm 106, support structures 108, and trimming system 110. Trimming system 110 is used to trim composite material 112 in its uncured state.

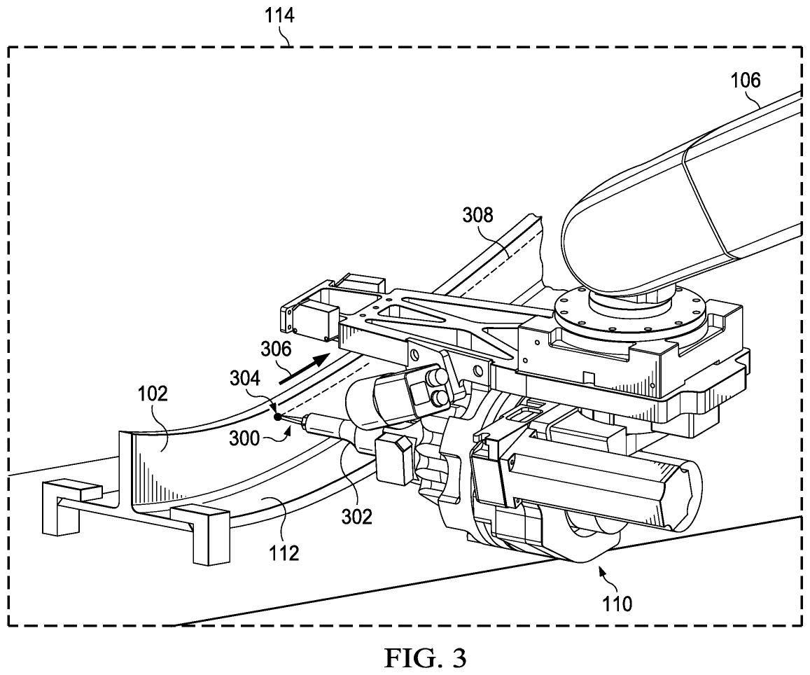

As depicted, robotic arm 106 is on rails 113. Rails 113 allow movement about the manufacturing environment. Section 114 with trimming system 110 and a portion of uncured composite structure 102 is shown in greater detail in FIG. 3.

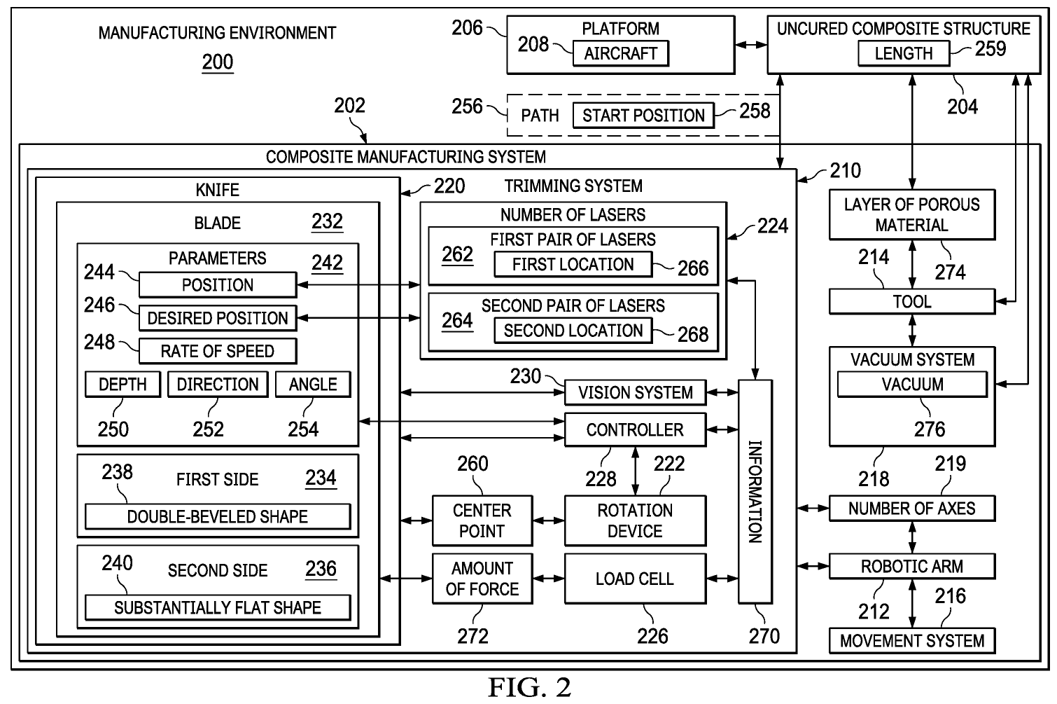

Turning now to FIG. 2, an illustration of a block diagram of a manufacturing environment is depicted in accordance with an illustrative embodiment. Manufacturing environment 200 is an environment where components within composite manufacturing system 202 may be used to fabricate a composite structure. Specifically, composite manufacturing system 202 is used to perform processes on uncured composite structure 204 in this illustrative example.

Uncured composite structure 204, after being cured, is a structure configured for use in platform 206. Platform 206 may be, for example, without limitation, a mobile platform, a stationary platform, a land-based structure, an aquatic-based structure, or a space-based structure. More specifically, platform 206 may be an aircraft, a surface ship, a tank, a personnel carrier, a train, a spacecraft, a space station, a satellite, a submarine, an automobile, a power plant, a bridge, a dam, a house, a manufacturing facility, a building, and other suitable platforms.

Platform 206 takes the form of aircraft 208 in this illustrative example. When uncured composite structure 204 is manufactured for aircraft 208, uncured composite structure 204 may be, for example, without limitation, a stringer, a spar, a rib, a panel, a stabilizer, a skin panel, or some other suitable structure configured for use in aircraft 208.

As depicted, composite manufacturing system 202 comprises trimming system 210, robotic arm 212, tool 214, movement system 216, and vacuum system 218. Trimming system 210 takes the form of an end effector for robotic arm 212 such that trimming system 210 is connected to robotic arm 212. Trimming system 210 may be removably connected to robotic arm 212 such that if robotic arm 212 is needed to perform other processes, trimming system 210 may be removed and another end effector can be attached to robotic arm 212. Robotic arm 212 moves trimming system 210 about number of axes 219 as desired relative to uncured composite structure 204.

As illustrated, tool 214 comprises multiple parts configured to support and hold uncured composite structure 204 in place during processing. Tool 214 may include one or more support structures such as a clamp, a bladder, a ballast, a block or some other suitable structure for holding uncured composite structure 204 in place during processing.

In this illustrative example, trimming system 210 includes knife 220, rotation device 222, number of lasers 224, load cell 226, controller 228, and vision system 230. As used herein, “a number of” when used with reference to items means one or more items. Thus, a number of lasers is one or more lasers.

Knife 220 takes the form of an ultrasonic knife in this illustrative example. Knife 220 comprises blade 232. Blade 232 has first side 234 and second side 236 opposite first side 234. First side 234 of blade 232 has double-beveled shape 238 while second side 236 of blade 232 has substantially flat shape 240. Flat shape 240 is a planar shape in this illustrative example. In other words, second side 236 of blade 232 has a flat surface. When cutting uncured composite structure 204, second side 236 with substantially flat shape 240 faces the trimmed part while first side 234 with double-beveled shape 238 faces the material to be discarded.

In this illustrative example, blade 232 of knife 220 has parameters 242. Parameters 242 include position 244, desired position 246, rate of speed 248, depth 250, direction 252, and angle 254 for blade 232 during trimming of uncured composite structure 204. Position 244 of blade 232 is the current location and orientation of blade 232 relative to uncured composite structure 204. Desired position 246 is the desired location and orientation for blade 232 to cut uncured composite structure 204 along path 256. Path 256 is a predetermined and programmed trim path in this illustrative example. Path 256 has start position 258 for blade 232. Blade 232 follows path 256 along the entire length 259 of uncured composite structure 204.

Rate of speed 248 is the rate at which blade 232 trims uncured composite structure 204. Depth 250 and angle 254 of blade 232 may be adjusted to provide a desired shape of cut for uncured composite structure 204. Direction 252 of blade 232 is changed based on a desired geometry for the cut. All of parameters 242 for blade 232 may be adjusted in real time in these illustrative examples.

As depicted, rotation device 222 is a device configured to rotate blade 232 of knife 220 about center point 260. Rotation device 222 takes the form of a rotary stage in this illustrative example. Rotation device 222 is configured to receive commands from controller 228 and rotates blade 232 accordingly.

Number of lasers 224 is configured to determine position 244 of blade 232 relative to desired position 246 for blade 232. Each of number of lasers 224 takes the form of a laser distance meter in this illustrative example, using the reflection from each laser to determine position 244 of blade 232.

In this illustrative example, number of lasers 224 comprises first pair of lasers 262 and second pair of lasers 264 associated with knife 220. First pair of lasers 262 is positioned in first location 266 relative to blade 232 of knife 220. In a similar fashion, second pair of lasers 264 is positioned in second location 268 relative to blade 232 of knife 220. For example, without limitation, first location 266 may be above blade 232 while second location 268 may be on either side adjacent to blade 232. Number of lasers 224 send information 270 to controller 228 to compare position 244 of blade 242 to desired position 246 for blade 232.

In this illustrative example, load cell 226 is a device associated with knife 220 and configured to sense amount of force 272 applied to blade 232 during trimming of uncured composite structure 204. Load cell 226 is a multi-axis load cell in this illustrative example. Load cell 226 sends information 270 to controller 228.

Controller 228 is a device that controls the behavior of the components within trimming system 210. Based on information 270 received from number of lasers 224, load cell 226, vision system 230, and other systems, controller 228 adjusts parameters 242 for blade 232 of knife 220. Specifically, controller 228 is configured to adjust at least one of rate of speed 248, direction 252, position 244, depth 250, and angle 254 of blade 232 based on information received from components in trimming system 210.

For example, without limitation, as the thickness of uncured composite structure 204 increases along path 256, controller 228 may slow down blade 232 to promote the integrity of the cut, reduce blade deflection, and reduce the risk of deformation of blade 232. In other cases, if the composite material is thin, blade 232 may move faster through these portions of uncured composite structure 204 to promote efficiency in processing. Adjustments in other parameters 242 allow for trimming of uncured composite structure 204 in multiple geometries and to correct blade 232 as desired in real time.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, “at least one of item A, item B, or item C” may include, without limitation, item A, item A and item B, or item B. This example also may include item A, item B, and item C, or item B and item C. Of course, any combination of these items may be present. In other examples, “at least one of” may be, for example, without limitation, two of item A, one of item B, and ten of item C; four of item B and seven of item C; or other suitable combinations.

As illustrated, vision system 230 comprises a number of components that provide visual feedback for trimming system 210. Vision system 230 may include a camera, a video camera, or other suitable components. Vision system 230 provides visual feedback as blade 232 cuts through uncured composite structure 204. For instance, vision system 230 may provide an image of blade 232 in position 244 such that a human operator may view the trimming process as it occurs. Vision system 230 provides information 270 to controller 228.

In this depicted example, movement system 216 is associated with robotic arm 212. Movement system 216 comprises various components configured to move robotic arm 212 along length 259 of uncured composite structure 204 to trim uncured composite structure 204. Movement system 216 may take the form of rails, wheels, or other suitable movement mechanisms. In some cases, movement system 216 and robotic arm 212 may comprise an autonomous vehicle capable of moving freely about manufacturing environment 200.

Prior to layup of uncured composite structure 204, layer of porous material 274 is placed over tool 214. In other words, layer of porous material 274 is positioned between uncured composite structure 204 and tool 214. Layer of porous material 274 may take various forms. For example, without limitation, layer of porous material may be a sheet comprise a material selected from at least one of polyethylene, polytetrafluoroethylene (PTFE), or some other suitable type of material. Layer of porous material 274 is porous such that vacuum 276 may be drawn on the materials. The pore size for layer of porous material 274 may vary, depending on the particular implementation.

Layer of porous material 274 is configured to prevent deflection of blade 232 into uncured composite structure 204. Layer of porous material 274 lifts uncured composite structure 204 off tool 214 in a desired manner. As a result, instead of deflecting toward uncured composite structure 204, blade 232 remains in a desired position to promote integrity of the cut. Auto stop features in the ultrasonic knife are not triggered because instead of hitting tool 214 and deflecting toward uncured composite structure 204, blade 232 cuts through layer of porous material 274. The thickness of layer of porous material 274 is selected to lift uncured composite structure 204 off tool 214 to prevent the stop feature and/or blade deflection. Various thicknesses may be used depending on the length of blade 232 or other parameters 242.

Vacuum system 218 comprises a number of components configured to draw vacuum 276 on tool 214, layer of porous material 274, and uncured composite structure 204. Vacuum 276 is pulled while blade 232 trims uncured composite structure 204.

With an illustrative embodiment, composite manufacturing system 202 can work more efficiently and with more versatility to trim uncured composite structure 204 than previously contemplated. As a result, uncured composite structure 204 is formed more quickly and with less rework than with currently used systems.

The illustrative embodiments are designed to create a smooth cut using asymmetric blade 232 and allow for trimming system 210 to cut uncured composite structures in multiple complex geometries. Robotic arm 212 moves trimming system 210 about uncured composite structure 204 such that flipping is not necessary, thus reducing manpower. In addition, the setup of tool 214 and layer of porous material 274 reduces deflection of blade 232. All parameters of blade 232 of knife 220 may be adjusted in real time, allowing trimming system 210 to perform more complex operations than previously used systems.

With reference next to FIG. 3, an illustration of a perspective view of a trimming system is depicted in accordance with an illustrative embodiment. FIG. 3 illustrates an example of physical implementations of components within composite manufacturing system 202 shown in block form in FIG. 2. A more-detailed view of section 114 from FIG. 1 is shown.

As depicted, blade 300 of knife 302 is placed near start position 304 for trimming uncured composite structure 102. Blade 300 moves in the direction of arrow 306 along path 308 to cut uncured composite structure 102 in a desired manner in this illustrative example. In some cases, it may be necessary for blade 300 to travel in the opposite direction. Trimming system 110 and robotic arm 106 are configured to accommodate movement along any axis.

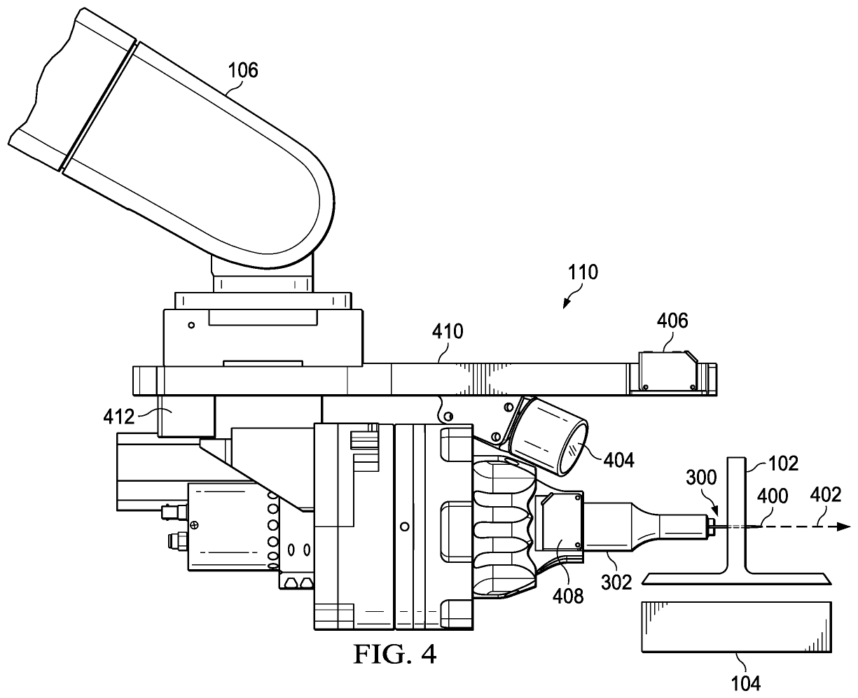

Turning now to FIG. 4, an illustration of a side view of a trimming system is depicted in accordance with an illustrative embodiment. FIG. 4 also illustrates an example of physical implementations of components within composite manufacturing system 202 shown in block form in FIG. 2. A cross-sectional view of uncured composite structure 102 is shown in this figure.

As illustrated, blade 300 of knife 302 pierced through uncured composite structure 102. Tip 400 of blade 300 can be seen cutting through uncured composite structure 102. As trimming system 110 moves, blade 300 may be rotated about center point 402 as desired.

Vision system 404, laser 406, and laser 408 are seen in this view. Support structure 410 provides a mounting surface for vision system 404 and laser 406.

Vision system 404 takes the form of a camera in this illustrative example. Laser 406 is mounted above knife 302 while laser 408 is mounted adjacent to knife 302. Laser 406 is one of a pair of lasers mounted above knife 302. In a similar fashion, laser 408 is one of a pair of lasers mounted adjacent to knife 302. Laser 406 and laser 408 are spot head lasers in this illustrative example.

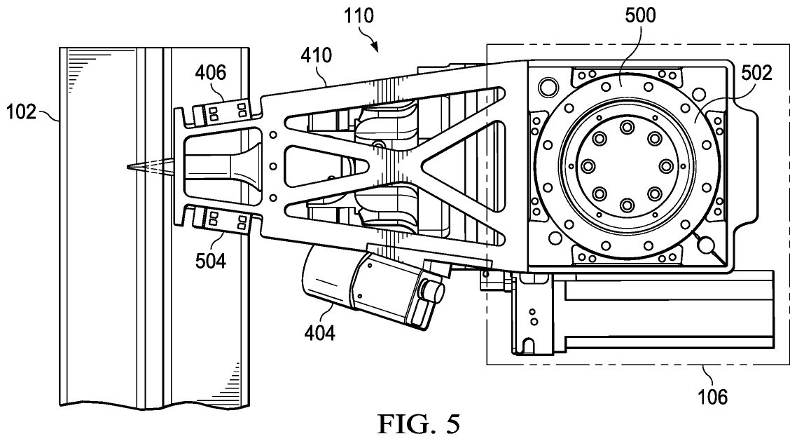

In FIG. 5, an illustration of a top view of a trimming system is depicted in accordance with an illustrative embodiment. In this illustrative example, robotic arm 106 is shown in phantom.

As depicted, connector 500 attaches trimming system 110 to robotic arm 106. Laser 504 is seen in this view. Laser 504 is paired with laser 406 and mounted above knife 302.

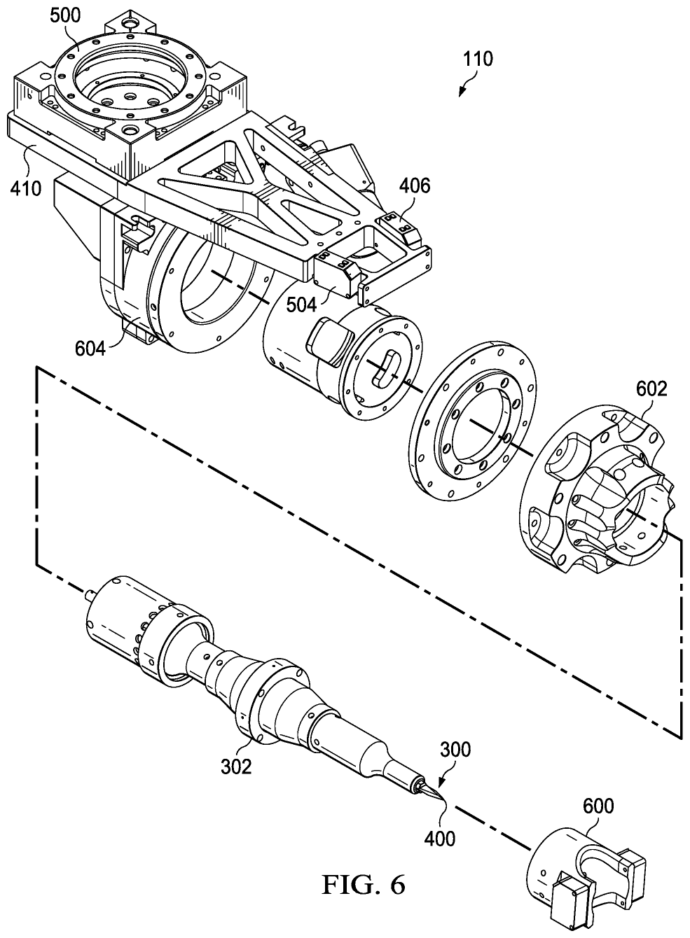

Turning next to FIG. 6, an illustration of an exploded view of a trimming system is depicted in accordance with an illustrative embodiment. In this illustrative example, clamp 600 and clamp 602 are shown. Clamp 600 and clamp 602 secure knife 302 to other components in trimming system 110. Rotary stage 604 provides rotation for blade 300 about its center point. Load cell 606 measures the amount of force applied to blade 300 during trimming.

FIG. 7 and FIG. 8 are illustrations of two sides of a knife blade in accordance with an illustrative embodiment. Side 700 of blade 300 is shown in FIG. 7 while side 800 of blade 300 is shown in FIG. 8. Blade 300 is an asymmetrical blade in this illustrative example. In other words, the shape of side 700 and side 800 are different.

As illustrated, side 700 of blade 300 has double-beveled shape 702. Side 800 has substantially flat shape 802. As blade 300 cuts through uncured composite structure 102, side 800 with substantially flat shape 802 is oriented inward toward the part while side 700 with double-beveled shape 702 is oriented outward toward the material being trimmed from uncured composite structure 102.

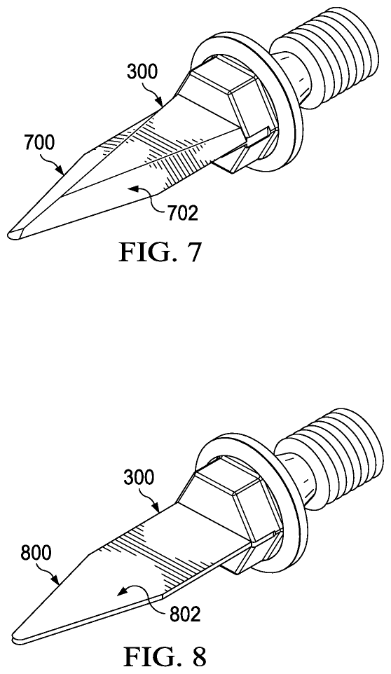

With reference next to FIG. 9, an illustration of a perspective view of a cut in an uncured composite structure is depicted in accordance with an illustrative embodiment. FIG. 9 shows asymmetrical blade 300 as it cuts through uncured composite structure 102.

In this illustrative example, distinct layers of composite material 112 are shown as blade 300 cuts off trimmed material 900. Blade 300 is moving in the direction of arrow 902 with side 700 facing outward and side 800 facing toward the final part.

As depicted, layer of porous material 904 has been positioned between tool 104 and uncured composite structure 102. Layer of porous material 904 is an example of a physical implementation for layer of porous material 274 shown in block form in FIG. 2. Layer of porous material 904 has thickness 906 enough to substantially prevent blade deflection or emergency stop features of blade 300 and knife 302.

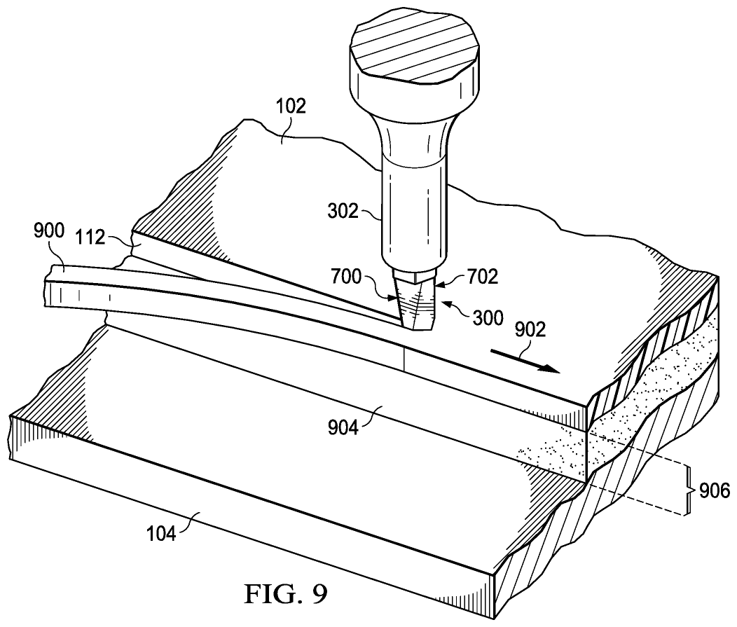

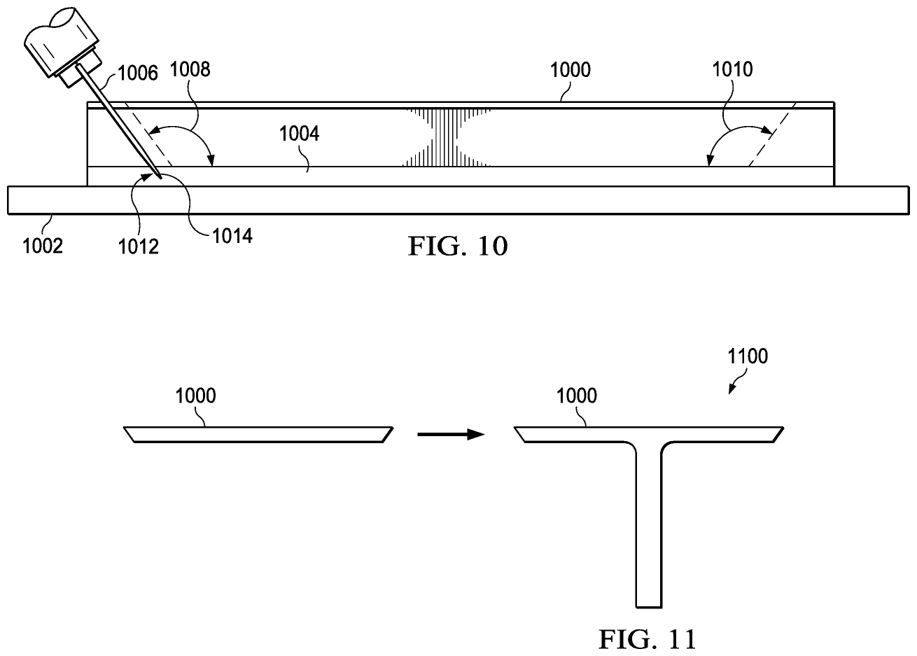

Turning to FIG. 10, an illustration of a cross-sectional view of a composite stringer is depicted in accordance with an illustrative embodiment. Composite structure 1000 is shown prior to being trimmed into its final shape.

As illustrated, composite structure 1000 is positioned on tool 1002. Layer of porous material 1004 is located between composite structure 1000 and tool 1002. Blade 1006 is used to trim composite structure 1000. Blade 1006 is an asymmetrical blade with a double-beveled side and a substantially flat side in accordance with an illustrative embodiment. Blade 1006 cuts composite structure 1000 along its length on angle 1008 and angle 1010.

As seen in this view, portion 1012 of blade 1006, including tip 1014, cuts into layer of porous material 1004 as blade 1006 trims composite structure 1000. Layer of porous material 1004, therefore, prevents blade 1006 from contacting tool 1002 and deflecting toward composite structure 1000.

FIG. 11 shows a cross-sectional view of a composite stringer in accordance with an illustrative embodiment. Composite structure 1000 from FIG. 10 is shown post trimming. Composite structure 1000 and other composite parts are used to form composite stringer 1100. Blade 1006 can trim uncured composite material without the need to reorient the charge, flip the assembly, or move the assembly from its position when laid up and consolidated.

The different components shown in FIG. 1 and FIGS. 3-11 may be combined with components in FIG. 2, used with components in FIG. 2, or a combination of the two. Additionally, some of the components in FIG. 1 and FIGS. 3-11 may be illustrative examples of how components shown in block form in FIG. 2 may be implemented as physical structures.

Other configurations for composite manufacturing system 100 may be implemented other than those shown in FIGS. 1 and FIGS. 3-11. For instance, although only one robotic arm with one trimming system is shown in FIG. 1 and FIGS. 3-11, two, three, five, or more robotic arms may be used at the same time. In such an illustrative example, the robotic arms may be performing the same processes or different processes at substantially the same time along the length of the composite structure. In other illustrative examples, uncured composite structure 102 may be held in an alternative configuration than shown herein.

Although the illustrative embodiments are shown and described with reference to forming stringers for aircraft applications, the illustrative embodiments can be used with any type of platform to trim composite parts for that platform. Moreover, although the illustrative embodiments are described with reference to a porous material. When a vacuum is not used, the material selected does not need to be porous. In other words, if cutting of the composite material is not completed under vacuum, the material need not be porous to enable an illustrative embodiment.

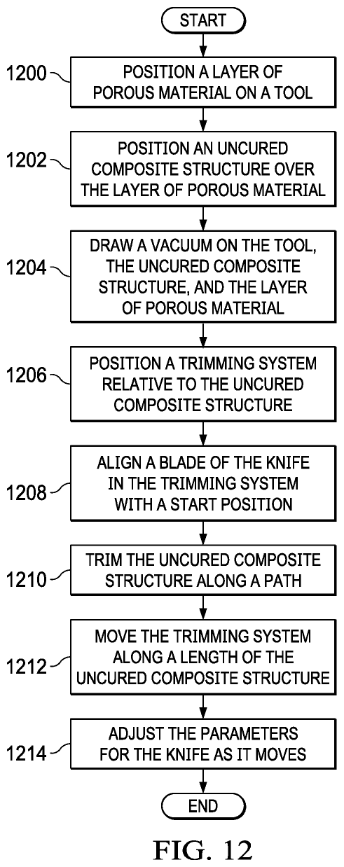

With reference next to FIG. 12, an illustration of a flowchart of a process for trimming an uncured composite structure is depicted in accordance with an illustrative embodiment. The method depicted in FIG. 12 may be used with trimming system 210 to trim uncured composite structure 204 in FIG. 2.

The process begins by positioning a layer of porous material on a tool (operation 1200). Next, an uncured composite structure is positioned over the layer of porous material (operation 1202). A vacuum is drawn on the tool, the uncured composite structure, and the layer of porous material (operation 1204).

Thereafter, a trimming system is positioned relative to the uncured composite structure (operation 1206). Next, the process aligns a blade of the knife in the trimming system with a start position (operation 1208). The process trims the uncured composite structure along a path (operation 1210). The trimming system is moved along a length of the uncured composite structure (operation 1212).

The process adjusts the parameters for the knife as it moves (operation 1214), with the process terminating thereafter. Adjusting the parameters for the knife may include rotating the knife about a center point using a rotation device integrated in the trimming system.

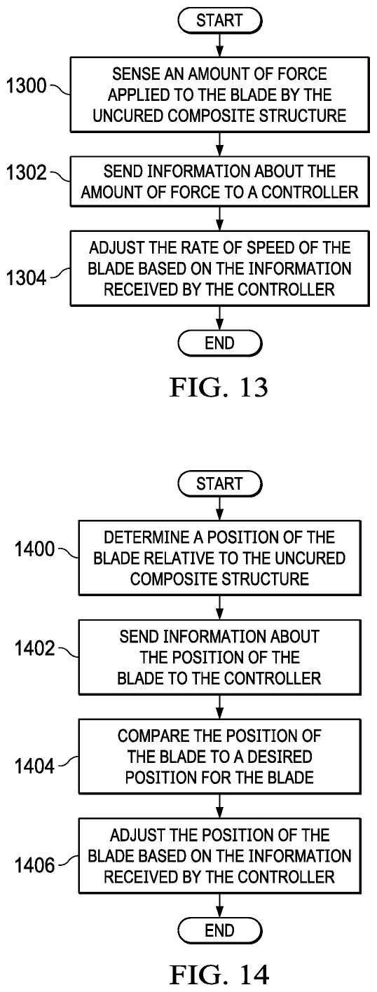

Turning now to FIG. 13, an illustration of a flowchart of a process for trimming an uncured composite structure is depicted in accordance with an illustrative embodiment. The method depicted in FIG. 13 may be used during operation 1214 from FIG. 12 to adjust the parameters of the blade of the knife during trimming.

The process begins by sensing an amount of force applied to the blade by the uncured composite structure (operation 1300). Next, the process sends information about the amount of force to a controller (operation 1302). The process then adjusts the rate of speed of the blade based on the information received by the controller (operation 1304), with the process terminating thereafter. At least one of the direction, the angle, and the depth of the blade also may be adjusted based on the information received by the controller.

Turning now to FIG. 14, an illustration of a flowchart of a process for trimming an uncured composite structure is depicted in accordance with an illustrative embodiment. The method depicted in FIG. 14 may be used during operation 1214 from FIG. 12 to adjust the parameters of the blade of the knife during trimming. Operations described with reference to FIG. 13 and FIG. 14 may occur substantially concurrently.

The process begins by determining a position of the blade relative to the uncured composite structure (operation 1400). Next, the process sends information about the position of the blade to the controller (operation 1402). The process then compares the position of the blade to a desired position for the blade (operation 1404). The process adjusts the position of the blade based on the information received by the controller (operation 1406), with the process terminating thereafter.

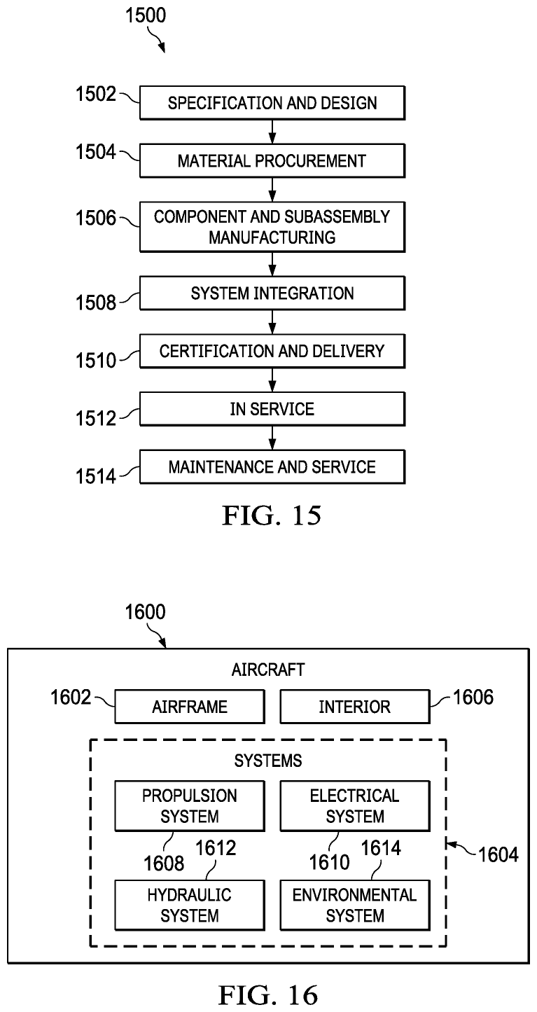

Illustrative embodiments of the disclosure may be described in the context of aircraft manufacturing and service method 1500 as shown in FIG. 15 and aircraft 1600 as shown in FIG. 16. Turning first to FIG. 15, an illustration of a block diagram of an aircraft manufacturing and service method is depicted in accordance with an illustrative embodiment. During pre-production, aircraft manufacturing and service method 1500 may include specification and design 1502 of aircraft 1600 in FIG. 16 and material procurement 1504.

During production, component and subassembly manufacturing 1506 and system integration 1508 of aircraft 1600 in FIG. 16 takes place. Thereafter, aircraft 1600 in FIG. 16 may go through certification and delivery 1510 in order to be placed in service 1512. While in service 1512 by a customer, aircraft 1600 in FIG. 16 is scheduled for routine maintenance and service 1514, which may include modification, reconfiguration, refurbishment, and other maintenance or service.

Uncured composite structure 204 from FIG. 2 may be made using composite manufacturing system 202 with trimming system 210 during component and subassembly manufacturing 1506. In addition, trimming system 210 may be used during routine maintenance and service 1514 as part of a modification, reconfiguration, or refurbishment of aircraft 1600 in FIG. 16.

Each of the processes of aircraft manufacturing and service method 1500 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers, and an operator may be an airline, a leasing company, a military entity, a service organization, and so on.

With reference now to FIG. 16, an illustration of a block diagram of an aircraft is depicted in which a composite structure made using an illustrative embodiment may be implemented. In this example, aircraft 1600 is produced by aircraft manufacturing and service method 1500 in FIG. 15 and may include airframe 1602 with plurality of systems 1604 and interior 1606. Examples of systems 1604 include one or more of propulsion system 1608, electrical system 1610, hydraulic system 1612, and environmental system 1614. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1500 in FIG. 15. In one illustrative example, components or subassemblies produced in component and subassembly manufacturing 1506 in FIG. 15 may be fabricated or manufactured in a manner similar to components or subassemblies produced while aircraft 1600 is in service 1512 in FIG. 15. As yet another example, one or more apparatus embodiments, method embodiments, or a combination thereof may be utilized during production stages, such as component and subassembly manufacturing 1506 and system integration 1508 in FIG. 15. One or more apparatus embodiments, method embodiments, or a combination thereof may be utilized while aircraft 1600 is in service 1512, during maintenance and service 1514 in FIG. 15, or both. The use of a number of the different illustrative embodiments may substantially expedite the assembly of aircraft 1600, reduce the cost of aircraft 1600, or both expedite the assembly of aircraft 1600 and reduce the cost of aircraft 1600.

With the use of an illustrative embodiment, a composite manufacturing system can work more efficiently with less risk of going offline due to blade deflection, damage, or poorly cut parts. As a result, composite structures are formed more quickly and with less rework than with currently used systems.

The illustrative embodiments also have precision control cutting capabilities. The knife blade can be adjusted in real time in multiple axes. The robotic arm travels the length of the composite structure without having to move the composite structure if so desired. More than one robotic arm can work on the composite structure simultaneously. With the use of an asymmetrical blade and a layer of porous material, consistency in cutting uncured composites can be realized.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added, in addition to the illustrated blocks, in a flowchart or block diagram.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A composite manufacturing system comprising:
a robotic arm; and
a trimming system connected to the robotic arm, the trimming system comprising:
a knife;
a rotation device configured to rotate a blade of the knife about a center point;
a number of lasers configured to determine a position of the blade relative to a desired position for the blade; and
a load cell associated with the knife and configured to sense an amount of force applied to the blade during trimming of an uncured composite structure.

2. The composite manufacturing system of claim 1 further comprising:
a controller configured to adjust parameters of the blade based on information received from the load cell.

3. The composite manufacturing system of claim 2, wherein the controller is further configured to adjust at least one of a rate of speed, a direction, the position, and a depth of the blade based on information received by the number of lasers.

4. The composite manufacturing system of claim 1, wherein the number of lasers comprises:
a first pair of lasers associated with the knife and positioned in a first location relative to the blade of the knife; and
a second pair of lasers associated with the knife and positioned in a second location relative to the blade of the knife.

5. The composite manufacturing system of claim 1, wherein the trimming system comprises:
a vision system configured to provide visual information as the blade cuts through the uncured composite structure.

6. The composite manufacturing system of claim 1, wherein the blade comprises:
a first side having a double-beveled shape; and
a second side opposite the first side having a planar shape, wherein the second side of the blade trims the uncured composite structure.

7. The composite manufacturing system of claim 6 further comprising:
a layer of porous material positioned between the uncured composite structure and a tool.

8. The composite manufacturing system of claim 7 further comprising:
a vacuum system configured to draw a vacuum on the tool, the layer of porous material, and the uncured composite structure while the blade trims the uncured composite structure.

9. The composite manufacturing system of claim 1 further comprising:
a movement system associated with the robotic arm and configured to move the trimming system along a length of the uncured composite structure to trim the uncured composite structure.

10. A method for trimming an uncured composite structure, the method comprising:
positioning a trimming system relative to the uncured composite structure, wherein the trimming system is removably connected to a robotic arm;
aligning a blade of a knife in the trimming system with a start position;
trimming the uncured composite structure along a path; and
adjusting parameters for the knife during trimming.

11. The method of claim 10, wherein adjusting the parameters of the knife comprises:
sensing an amount of force applied to the blade by the uncured composite structure;
sending information about the amount of force to a controller; and
adjusting a rate of speed of the blade based on the information received by the controller.

12. The method of claim 11 further comprising:
adjusting at least one of a direction, an angle, and a depth of the blade based on the information received by the controller.

13. The method of claim 12, wherein adjusting the angle of the blade comprises:
rotating the knife about a center point using a rotation device.

14. The method of claim 10 further comprising:
determining a position of the blade relative to the uncured composite structure;
sending information about the position of the blade to a controller; and
adjusting the position of the blade based on information received by the controller.

15. The method of claim 10 further comprising:
moving the trimming system along a length of the uncured composite structure to trim the uncured composite structure.

16. The method of claim 10, wherein the blade has a first side with a double-beveled shape and a second side with a planar shape, and further comprising;
positioning a layer of porous material between the uncured composite structure and a tool;
drawing a vacuum on the tool, the uncured composite structure, and the layer of porous material; and
trimming the uncured composite structure using the second side of the blade having the planar shape.

17. A composite manufacturing system for trimming an uncured composite structure, the composite manufacturing system comprising:
a tool, wherein the uncured composite structure is laid up on the tool;
a robotic arm; and
a trimming system connected to the robotic arm, the trimming system comprising:
a knife having a blade rotatable about a center point;
a rotation device associated with the blade;
a number of lasers;
a load cell associated with the knife; and
a controller.

18. The composite manufacturing system of claim 17 further comprising:
a layer of porous material positioned between layers of composite material and the tool.

19. The composite manufacturing system of claim 18 further comprising:
a vacuum system.

20. The composite manufacturing system of claim 18, wherein the blade comprises:
a first side having a double-beveled shape; and
a second side opposite the first side having a planar shape, wherein the blade trims the uncured composite structure using the second side.
